(19) United States
(12) Patent Application Publication
(10) Pub. No.: US 2020/0355945 A1
(43) Pub. Date: Nov. 12, 2020

(54) EQUIPMENT TO OBTAIN 3D IMAGE DATA OF A FACE AND AUTOMATIC METHOD FOR CUSTOMIZED MODELING AND MANUFACTURING OF EYEGLASS FRAMES

(71) Applicant: SEQUOIA CAPITALL LTDA., Sao Paulo (BR)

(72) Inventors: Márcio ABDO SARQUIS ATTIÉ, Sao Paulo (BR); Eston ALMANÇA DOS SANTOS, Sao Paulo (BR)

(73) Assignee: Sequoia Capital LtdA., Sao Paulo (BR)

(21) Appl. No.: 16/095,552

(22) PCT Filed: Apr. 19, 2017
(86) PCT No.: PCT/BR2017/050095

§ 371 Date: Oct. 22, 2018

(30) Foreign Application Priority Data
Apr. 22, 2016 (BR) 10 2016 009093.8

(51) Int. Cl. G02C 13/00; H04N 5/247; H04N 5/232; H04N 5/04; G06T 17/00; G06K 9/00; G06T 19/20

(52) U.S. Cl. CPC G02C 13/003; H04N 5/247; H04N 5/23222; H04N 5/23206; H04N 5/04; G06T 2200/04; G06T 17/00; G06K 9/00248; G06T 19/20; G06T 2219/2004; G06T 2219/2024; H04N 5/23238

(57) ABSTRACT

The invention concerns an equipment and method where an eyeglass frame selected by the user is automatically modeled by adjusting it in a customized way to the specific features of the individual's face, allowing personalization of additional, desired or required aspects. The method is executed in a capture module (100), positioned in public locations of major circulation of people, equipped with several capture devices (200) intended to transmit captured bidimensional images via Internet to a remote application server in charge of processing and generating a tridimensional model of the user's face, as well as in charge of storing image therefore allowing the user to select and personalize the desired frame, at any time.

### TECHNICAL FIELD OF THE INVENTION

This invention concerns an equipment to obtain 3D image data of a human face and an automatic method for customized modeling of eyeglass frames. More specifically, this invention concerns an automatic process for customized modeling of a frame selected by the user with capacity to personalize and manufacture the frame model selected.

### GROUNDS OF THE INVENTION

Since the idealization of the first corrective lenses manufactured with semiprecious stones by the Arabian mathematician Alhazen, who around the year 1000 AD formulated a theory of light incidence on mirrors, the progressive acculturation of humanity and the disclosure of ideas under the written form, no longer oral, has made the glasses essential items to correct the loss of visual acuity, as well as to reduce the excess of sensitivity, eventually caused by luminous rays of any kind.

Regardless of the reason to wear glasses, this implies in the selection of a competent frame to support lenses, and how the latter fit the face of the users.

Currently there are ranges of frame sizes and models according to certain anthropometric dimensions selected following the most common biotypes among individuals. Therefore, those not falling within those patterns or that are located at the dimensional edge between sizes or even those that suffered some kind of deformation such as following an accident or abnormal congenital cranial formation will face difficulties when selecting and using such utensil.

Thus, selection of frame glasses is made with the assistance of a professional that, having previous knowledge of what types of frames are more appropriate to the most common face shapes, is more qualified to provide options to the user of several models and sizes following direct measurements in order to determine the dimensional range within the chosen models.

Even though there are many already developed initiatives to automatize the frame choosing step, the existing processes simply replace the assistance of a human professionals by a database with options to allow the user, usually not an expert in the subject, to pick a frame of his/her own choosing not taking into account the correct spacing between lenses and pupils, nasal fixation, frontal area covered by the lenses, etc., which are critical, especially when the glasses are intended to corrective use of some refractive error.

When it comes to select the glasses for recreation use or as a clothing accessory, such as sunglasses, this situation is worsened because the incorrect use of this item can result in discomfort and visual issues either due to the poor quality of the lenses or its poor fixation and incorrect positioning.

The use of eyeglasses as personal protection equipment is also relevant, as the correct fixation aspect resulting from the perfect adjustment to the user's face is of vital importance to obtain the desired safety effect. Frame model options are even more restrictive to those individuals depending on the utilization corrective lenses and performing risk activities where protection is required.

In other situations, the adoption of distinguished elements and signs on frames is highly desirable, as for example, in advertising campaigns or to identify companies, people or teams with specific functions.

### STATE OF THE ART

There are initiatives trying to develop systems and procedures to automatize and improve the task of selecting an eyeglass frame in order to adequately adjust the utensil to the face of a specific user.

A widely-deployed method, including in other technical areas, consists in 3D scanning or digitalization, where a tridimensional image is obtained and then processed to be reconstituted by means of a triangular mesh that describes the particular contours and nuances of the individual's face.

This procedure created by the mechanical engineering shows great precision, however, it does not grant specific advantages for the case in question, in addition to demand high computational power to process the data obtained and to build the face's descriptive mesh.

The images are obtained, in this case, by specific equipment, which makes difficult the disclosure of its use, due to its cost or operation, as it requires specialized professionals in order to obtain the expected results.

An alternative way is by acquiring a series of digital photos around the face of individuals under specific conditions that allow the reconstruction of the dimensions within the required tolerances from the images obtained. This way, cameras take images in different angular positions in relation to the individual's face, which permit the digital reconstruction of its tridimensional image.

Such conditions include controlled alignment and distancing, between the face and camera(s), and also the use of scales that allow dimensions to be restored by comparison and relative proportion.

Following the restoration of dimensions, it is then possible to follow the previous reconstitution path of the tridimensional image by building the triangular mesh with the digital processing load involved, or even use computational vision techniques, in which, by means of specific comparisons it is possible to obtain facial points of interest to draw and select eyeglass frames. From the last mentioned mode results are obtained with the employment of less electronic data processing and storage resources.

Technological efforts trying to solve the difficulties mentioned above can be found not only in patent documents but also in academic articles.

In document U.S. Pat. No. 5,175,941, Ziegler & Kremer propose a method and a device to objectively systematize measurements taken in order to select the most indicated frames for each user given the lack of standardization of the systems used at the time. It is worth emphasizing that this standardization is not completely possible or desired in most cases, such as in situations of victims from accidents with facial damages or individuals born with congenital cranial deficiencies.

In document U.S. Pat. No. 5,592,248, Norton describes the selection of the frame that best adapts to the photographed face of the user, using database of frames so that users, which are not always area experts, select the frame they like the most. However it does not detail how facial points of interest are obtained and there is no solution to situations out of the predetermined patterns.

A more advanced solution is the one proposed by Dreher in document U.S. Pat. No. 6,682,195, which makes use of an equipment capable of analyzing wave refraction, as well as materials moldable to the user's face and several photographic cameras in order to obtain the measures of the user's head dimensions seeking the correct alignment of his/her glasses. Even though it aimed at automation, it still lacks adequate solution to the frame selection capacity by the own user in order to avoid compromising the correct use of the accessory.

Saffra, in documents U.S. Pat. Nos. 7,959,287 and 8,220,923 shows how to obtain measurements of the facial points of interest in order to select frames in a more efficient way for each user within the cranial measurement ranges. The proposed system is of direct measurement with scales in the individual's face and the selection of models is still made by a database of anthropometric patterns, therefore excluding, once again, those with some deficiency or similar issue that prevents them from falling within the scope of such patterns.

Additionally, it does not mention the possibility to customize frame dimensions in order to perfectly adjust to the face of a specific user or the several possibilities opened by personalizing the aesthetic aspects of the final product, which are the subject of this invention.

In the academic scope of the design, Bertol and collaborators—in “3D digitalization as a tool to customize eyeglass frames”, presented at the 11th Brazilian Design Congress in Sao Paulo, 2010—demonstrated the use of complex digitalization and manufacturing tools, exclusively automatic, of frames that limit the employment of the innovation and also of the materials subject to be used on frames. It also defines customization as the dimensional adjustment of the frame to the face, and it does not explore the functional and aesthetic possibilities offered by the available means.

Still following the academic scope, we can mention some articles with algorithms developed in order to identify and analyze anthropometric measures and elements of the face, such as: (1) Tieniu Tan, Zhaofeng He, Zhenan Sun. Efficient and robust segmentation of noisy iris images for non-cooperative iris recognition. Image and Vision Computing, v. 28, p. 223-230, 2010; (2) Zhaofeng He, Tieniu Tan, Zhenan Sun and Xianchao Qiu. Toward Accurate and Fast Iris Segmentation for Iris Biometrics. IEEE Transactions on Pattern Analysis and Machine Intelligence, v. 31, n. 9, 2009; (3) Lynn M. Matsuda, Constance L. Woldorff, Rodger T. Kame, Jon K. Hayashida. Clinical Comparison of Corneal Diameter and Curvature in Asian Eyes with Those of Caucasian Eyes. Optometry and Vision Science, v. 69, n. 1, p. 51-54, 1992; (4) Paul Viola and Michael J. Jones. Rapid Object Detection using a Boosted Cascade of Simple Features. IEEE CVPR, 2001; (5) Rainer Lienhart and Jochen Maydt. An Extended Set of Haar-like Features for Rapid Object Detection. IEEE ICIP, Vol. 1, pp. 900-903, 2002.

Other attempts to use digitalization and customization technologies are brought by a project from the North-American company Protos. This project allows the user to select a frame model and to virtually evaluate as it appears positioned on his/her face. The dimensional parameterization to assess dimensions and determine interest points is made by means of an external scale, using a plastic card, for example, a credit card. The proposed constructive process limits the range of materials and does not explore personalization.

As demonstrated, the state of the art still lacks a customization (or adequacy) automatic process for eyeglass frames and physical characteristics of the user's face, including those with deformities, that is both efficient and accessible by the general public, also allowing frame personalization with graphisms or reliefs, and their subsequent manufacturing, respecting all parameters set out for and by the user.

### SUMMARY OF THE INVENTION

As a way to consolidate several technological alternatives and provide an appropriate choice, both technical and aesthetic, to the users of eyeglasses, this invention describes an equipment designed to obtain 3D image data of a face and a method where a frame selected by the user is automatically modeled, adjusting itself in a customized manner to the specific features of the individual's face, also allowing the personalization of additional, desired or required aspects in the frame model, resulting in its manufacturing.

The method subject of this invention can be used by any user, as it dismiss the requirement of knowing technical aspects in order to be operated, and it will be started in an equipment to obtain 3D image data that will be denominated as a capture module throughout this report, which is specific for the purpose of obtaining images of the whole facial area of the user.

Such capture modules, positioned in public locations of major circulation of people, are equipped with several digital cameras, hardware and control program specific for the transmission of captured images via Internet to a remote application server in charge of processing and generating a tridimensional model of the user's face, as well as of storing such image, thus allowing the user to select and customize the desired frame, regardless if such image is currently inside the capture module or in a future moment.

An additional aspect of the referred process allows the user to personalize the selected frame model with graphisms, phrases, reliefs, etc., obtaining a unique utensil not only in face adjustment but also in comparison to similar ones.

### BRIEF DESCRIPTION OF THE DRAWINGS

The characteristics of this invention will become apparent from its detailed description, which must be analyzed in connection with the exemplary drawings attached to this report where:

FIG. 1 shows a flowchart containing all steps of the automatic process concerning selection, customization and personalization of eyeglass frames object of this invention;

FIG. 2 shows a graphic diagram containing all steps of the automatic process concerning selection, customization and personalization of eyeglass frames object of this invention;

FIG. 3 shows a global view of the capture module;

FIG. 4 shows a frontal image of a capture device;

FIG. 5 shows a posterior image of the capture device;

FIG. 6 shows a perspective image of the capture device with details of the folding on the articulated supports of the USB connectors;

FIG. 7 shows a schematic image of the capture device's hardware set;

FIG. 8 shows the logical architecture of the capture control program;

FIG. 9 shows a spatial image of the casing structure with alveolar shape and several installed image capture devices;

FIG. 10 shows an exploded view of the cover with a hollow sphere shape and a grid of image capture devices, as well as casing structure with alveolar shape of the capture module;

FIG. 11 shows an option of the user's face scanning angle performed inside the capture module; and

FIG. 12 shows another option of the user's face scanning angle performed inside the capture module.

### DETAILED DESCRIPTION OF THE INVENTION

This invention proposes and equipment to obtain 3D image data from a face and a method where a specific frame selected by the user is automatically modeled, adjusting itself in a customized manner to the facial features of the referred user, thus allowing the personalization of additional, desired or required aspects of the frame model and its posterior manufacturing.

The method to obtain and process digital images described hereunder is capable of being used by any user, allowing individuals without technical knowledge to be able to provide the required information to confect a frame adjusted in an optimal way to their faces.

The equipment for 3D image data acquisition of a face comprises:
a capture module (100), which is provided with hollow sphere-shaped cover (101) and dimensions ranging from 60 cm to 70 cm diameter, parallel and sectioned by a secant plane, distancing 45° from the central sphere axis, forming a circular gap of 40 to 50 cm diameter, which serves to internally accommodate the head of the user;
an alveolar-shaped casing structure (102) internally arranged in the cover (101) with the purpose of supporting several image capture devices (200);
a pedestal-shaped support structure (104) or an articulated arm fixed to a wall or similar vertical surface and the cover (101) of the capture module (100), which is intended to withstand the latter, provided with articulations that allow regulation of its vertical and horizontal positioning, granting mobility and allowing its adaptation to the physical features of each user;
a Tablet PC (103), positioned at the frontal area next to the edge of the circular gap of the capture module (100), which communicates with the image capture devices (200) and performs an interactive programming intended to guide users in the correct positioning of their faces within the capture module (100) in order to activate the synchronized shot of the capture devices (200) during image acquisition.

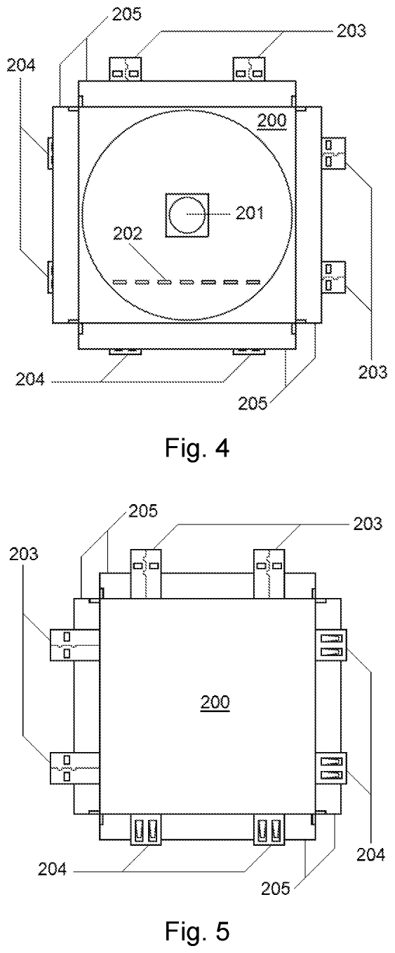

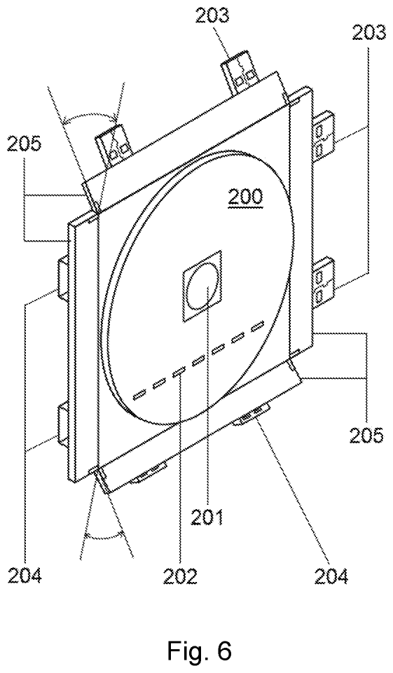

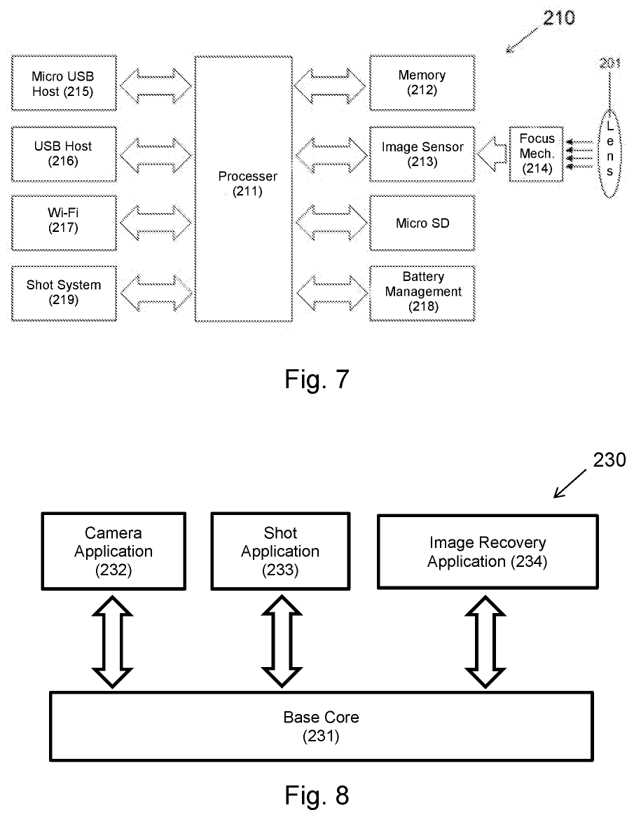

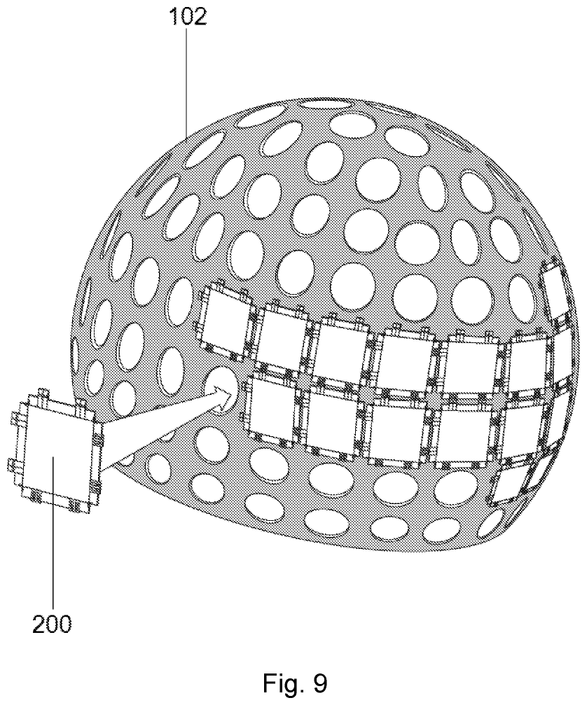

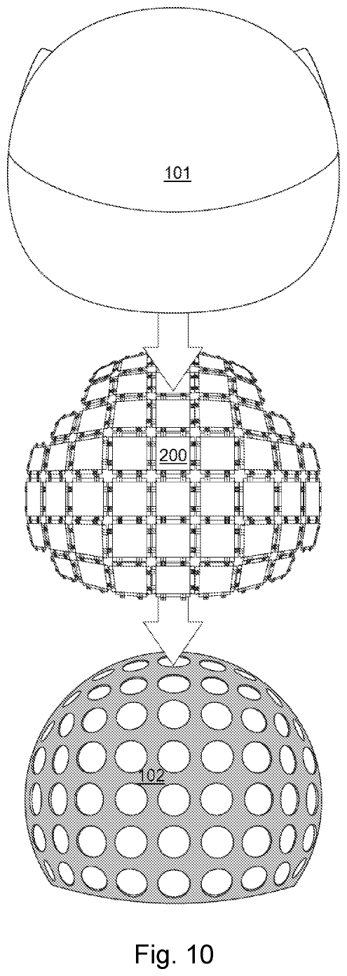

The image capture device (200) as shown in FIGS. 4 and 5 has a squared-shaped support with a lens and camera (201), flash leds (202), a control circuit (210) to a device containing: an electronic board with processer (211), memory (212), image sensor module (213), image focus mechanism (214), communication by connectors USB, micro USB host (215) and USB host (216), communication by Wi-Fi (217), battery management system (218), flash (202) and shot control system (219) in its frontal face, which remains pointed at the user's face; USB connectors pairs, males (203) and female (204) are arranged in an alternate manner in articulated supports (205), which allow said USB connectors to be folded in an angle of up to 45° as shown in FIG. 6, therefore allowing its assembly on round surfaces and in series, with several arrangements without damaging the contact between the series of capture devices (200) intended to be used, and such devices can be, for example, selected among: single strip format, double strip format, or even a grid mounted on the casing structure (102), in the capture module (100) as shown in FIGS. 9 and 10.

The shot system (219) of the control circuit (210) of the image capture device (200) allows synchronized capture and posterior recovery of the obtained images.

The shot system (219) offers two synchronization and activation mechanisms:
via network (a), based on accurate synchronism of digital clocks included in the electronic board of each image capture device (200), which are controlled by the processor (211); and upon being initialized the devices execute a synchronization routine from the NTP protocol. This allows adjustment of the internal clock of each board in relation to the server clock with a precision above 1 millisecond and once clocks are synchronized a shot signal is sent to the equipment with a scheduled moment to perform the capture; or
via external signal (b), based on emission and reception of a light signal at the infrared frequency range, also called IR, shot in the environment and received by the different cameras by means of a IR sensor.

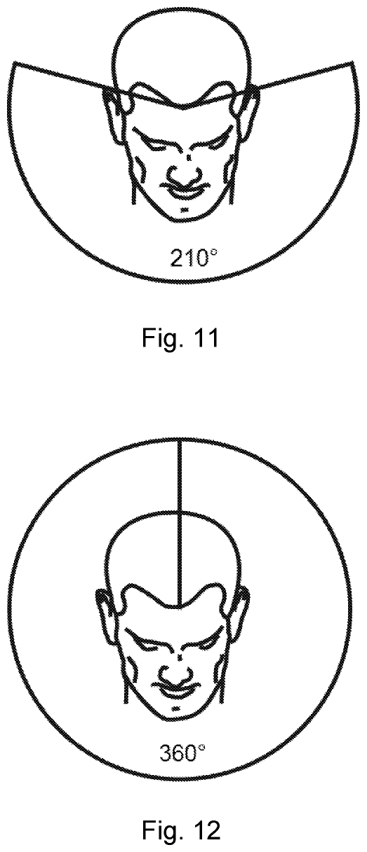

Image capture devices (200) are available within the capture module (100) forming a capture angle from 210° to 360° around the head of the user as shown in FIGS. 11 and 12.

The control program (230) of the image capture device (200) comprises: base core (231), camera application (232), shot application (233) and image recovery application (234).

The operation of the control circuit (210) and of the control program (230) of the image capture device (200) makes possible the synchronized capture of images thanks to several image capture devices (200) mounted on the same arrangement (setup) and also allow the transmission of such images by means of USB or Wi-Fi communication to a remote application server.

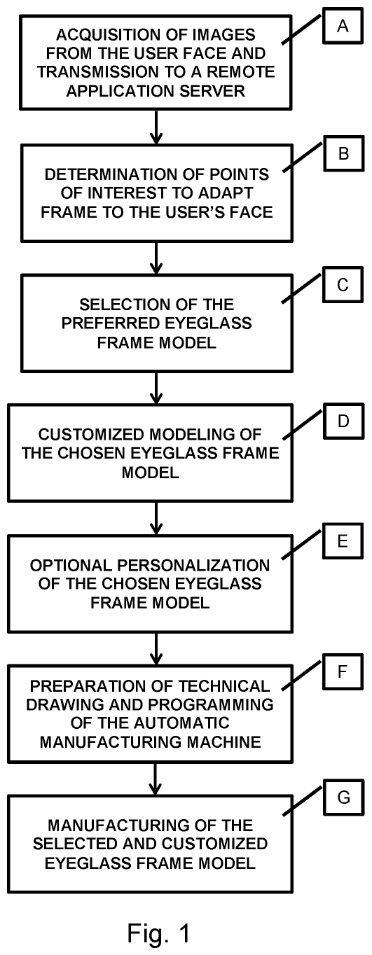

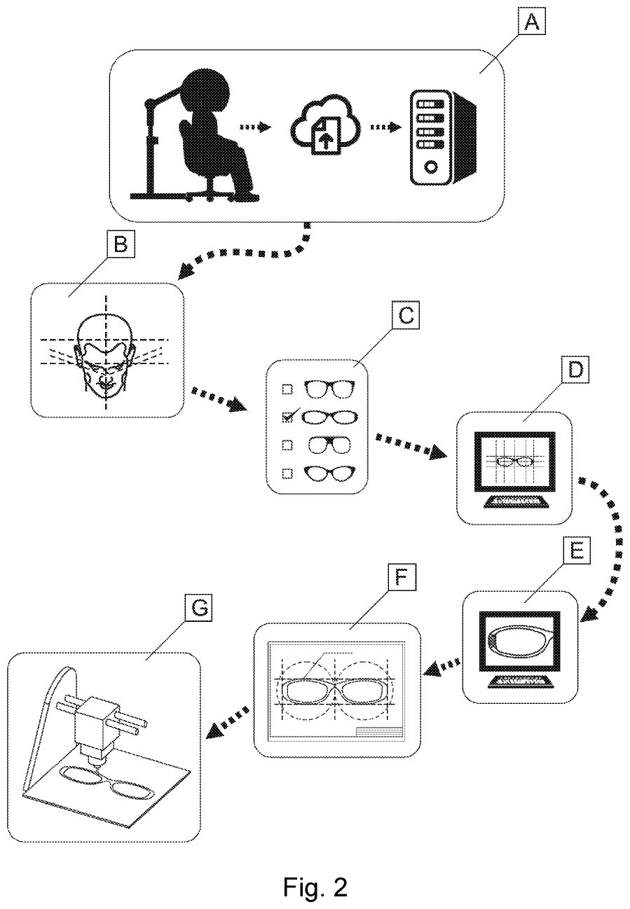

The automatic method for customized modeling and manufacturing of eyeglass frames, object of this invention, as shown and summarized in FIGS. 1 and 2, comprises the following steps:
A. ACQUISITION of a series of bidimensional images from several user's face angles, obtained by a capture module (100) and transmitted to a remote application server;
B. DETERMINATION of tridimensional image points of interest of the user's face performed in a remote application server and built by means of images obtained in capture module (100);
C. SELECTION by the user in any terminal connected to the Internet of the desired eyeglass frame model among a wide range of models offered;
D. CUSTOMIZED MODELING of a selected eyeglass frame according to the data from the tridimensional image points of interest generated and to the measurement of iris diameter, as well as to the personal data of the user such as gender, race and age group;
E. PERSONALIZATION (optional) with aesthetic or functional elements added by the user to the eyeglass frame model selected and modeled in a customized manner to the user's own facial features;
F. PREPARATION of technical drawing and sending of programming to a manufacturing machinery to manufacture the chosen eyeglass frame model in a customized manner according to the facial features and optionally personalized by the user; and
G. MANUFACTURING (automated) of the selected eyeglass frame model, modeled in a customized manner and optionally personalized by the user.

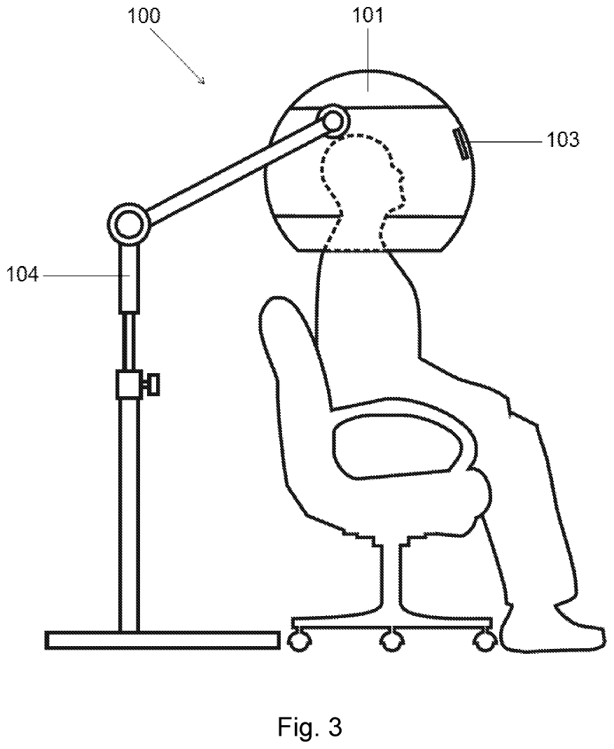

The initial step of the process described in this invention concerning the acquisition (A) of the user's face image is performed in the capture module (100) as shown in FIG. 3, specifically developed for that purpose and preferably positioned in public access locations with major traffic of people such as malls, bus stations and airports.

The image capture devices (200) have specific electronics and programming to capture a series of bidimensional image series from several angles of the user's face, and then transmit them via Internet to an application server located remotely from the capture site, which is in charge of processing, generating and storing a tridimensional model of the user's face (B), allowing individuals to select (C) and personalize (E) the desired frame posteriorly, eventually in the capture module or in a future moment, at any computational equipment with access to the Internet.

Capture of images from the user's face can be performed with the simultaneous shot of a variable number ranging from 5 to 40 of image capture devices (200).

In possession of the user's face images obtained and transmitted by image capture devices (200) at the acquisition step (A) the control program (230) running in the remote application server will determine the points of interest of the user's face tridimensional image (B) so that any selected frame is automatically adjusted and modeled in a customized manner to the dimensional characteristics of the referred user's face.

More specifically the definition of points of interest of the user's face uses independent algorithms to identify iris and detect ears, by analyzing the signals related to frontal and side images of the user's face.

Based on the frontal image of the user's face, in addition to identify the iris, the algorithm executes the following functions:
1. Identification of facial points of interest (pupil, right and left corners of each eye and eyebrow base), as well as gender, ethnics and age group are extracted.
2. With such points of interest two rectangular cuts can be defined in the picture, which are the regions of each one of the eyes. This rectangular cut shows the following characteristics:
   a. Width=1.5×(distance between the right and left corners);
   b. Height=2×(distance between pupil and eyebrow base);
   c. Center in the pupil.
3. Each eye uses an iris detection algorithm with adaptations defined by Tan, which describes the following:
   a. Removal of reflex;
   b. Identification of iris and skin regions;
   c. Identification of the iris circumference through the integral and differential operator.
4. Result is the identification of two circumferences (center and radius) in the picture that represent the right and left iris.
5. Measure of the iris diameter is inferred from the relationship between pixels of the image and actual measure in millimeters. In order to do so, it is used the study made by Matsuda, which presents average iris diameters concerning gender (male/female), race (Asiatic/Caucasian) and age.

Based on a side image of the face and the algorithm used to detect the ear, the following functions are executed:
1. Identification of the ear in the picture is done by means of a cascaded classifier using attributes such as Haar, proposed by Paul Viola and improved by Rainer Lienhart. This classifier was previously refined with hundreds of images with positive (ears) e negative (arbitrary images without ears) examples.
2. Once the ear is detected, a search is made in the image (starting with the ear) in order to find the person's eye. This search is made according to a specific algorithm that finds the horizontal gradient of the image and makes a search from the position of the ear position to the direction of the eye (right if picture from the right ear and left if picture from the left ear) by a point with accentuated gradient. Such point is the eye.

An additional aspect of Step B—where the definition of user's facial points of interest occurs—consists in the utilization of specific algorithms based on inference that performs the previous identification of the gender, race and age group of the user. Such information is extremely important to process the customized modeling (D) and all such information is confirmed before the beginning of the selection process (C).

Frames obtained by the method proposed in this invention have dimensional tolerances within the international standards for conventional methods of computational optics.

One of the aspects of the invention allows the user to select (C) the desired frame within a set of different models and styles, colors and shapes, including frames from renowned designer brands, all subject to customization (D) according to the user's facial features and manufactured (G) in such a way that it keeps the visual identity conferred by the brand, as well as its own peculiar design.

One additional aspect of the invention allows the user to personalize (E) the frame model, diverging from those of renowned designer brands, as well as to select graphisms, phrases, reliefs, etc. thus obtaining a unique utensil not only to the adjustment of the face (D) but also exclusive when compared to similar ones.

Another aspect of the invention allows the user to visualize the frame selected (C), which is virtually positioned to his/her face, including applied customizations, in order to conclude the customization (D) and personalization (E) steps in a safe way, assisted by the pre-viewing capacity of the frame applied to the face, which will influence the user's final decision on the manufacturing (G) of the utensil just modeled in a customized manner.

Another aspect of this invention allows the manufacturing (G) of the eyeglass frames perfectly adjusted to the face of users that suffered traumas such as accidents or congenital facial deformities, allowing such users to use eyeglass comfortably, either for refractive error correction or just as sunglasses.

The method object of this invention allows the manufacturing (G) of eyeglass frames using as raw material, materials that can be chosen among: acetate, titanium, wood, silver, gold, etc.

Automatic manufacturing machines used in the manufacturing process (G) of the process claimed in this invention are Milling Machines operated by CNC (Computer Numerical Control).

Even though this invention has been particularly shown and described with exemplary references, it will be understood by those aware of the technique that several changes in the form and details may be made in it without deviating from the scope of this invention as supported by its claims.

1. EQUIPMENT TO OBTAIN 3D IMAGE DATA OF A FACE, characterized by comprising:
a capture module (100), which is provided with hollow sphere-shaped cover (101) and dimensions ranging from 60 cm to 70 cm diameter, parallel and sectioned by a secant plane, distancing 45° from the central sphere axis, forming a circular gap of 40 to 50 cm diameter, which serves to internally accommodate the head of a user;
an alveolar-shaped casing structure (102) internally arranged in the cover (101) with the purpose of supporting several image capture devices (200);
a pedestal-shaped support structure (104) or an articulated arm fixed to a wall or similar vertical surface and the cover (101) of the capture module (100), which is intended to withstand the latter, provided with articulations that allow regulation of its vertical and horizontal positioning, granting mobility and allowing its adaptation to the physical features of each user;
a Tablet PC (103), positioned at the frontal area next to the edge of the circular gap of the capture module (100), communicates with the image capture devices (200) and performs an interactive programming intended to guide users in the correct positioning of their faces within the capture module (100) in order to activate the synchronized shot of the capture devices (200) during image acquisition.

2. EQUIPMENT TO OBTAIN 3D IMAGE DATA OF A FACE, according to claim 1, characterized by the image capture device (200) having a squared-shaped support with a lens and camera (201), flash leds (202), a control circuit (210) to a device containing: an electronic board with processor (211), memory (212), image sensor module (213), image focus mechanism (214), communication by connectors USB, micro USB host (215) and USB host (216), communication by Wi-Fi (217), battery management system (218), flash (202) and shot control system (219) in its frontal face, which remains pointed at the user's face; USB connectors pairs, males (203) and female (204) are arranged in an alternate manner in articulated supports (205), which allow said USB connectors to be folded in an angle of up to 45°, therefore allowing its assembly on round surfaces and in series, with several arrangements that can be, for example, selected among: single strip format, double strip format, or even a grid mounted on the casing structure (102), in the capture module (100).

3. EQUIPMENT TO OBTAIN 3D IMAGE DATA OF A FACE, according to claim 1, characterized by the shot system (219) of the control circuit (210) of the image capture device (200) to allow synchronized capture, further recovery of images obtained and offer two synchronization and activation mechanisms:
via network (a), based on accurate synchronism of digital clocks included in the electronic board of each image capture device (200), which are controlled by the processor (211); and upon being initialized the devices execute a synchronization routine from the NTP protocol. This allows adjustment of the internal clock of each board in relation to the server clock with a precision above 1 millisecond and once clocks are synchronized a shot signal is sent to the equipment with a scheduled moment to perform the capture; or
via external signal (b), based on emission and reception of a light signal at the infrared frequency range, also called IR, shot in the environment and received by the different cameras by means of a IR sensor.

4. EQUIPMENT TO OBTAIN 3D IMAGE DATA OF A FACE, according to claim 1, characterized by the image capture devices (200) be arranged within the capture module interior (100), forming a capture angle from 210° to 360° around the user's head.

5. EQUIPMENT TO OBTAIN 3D IMAGE DATA OF A FACE, according to claim 1, characterized by the control program (230) of the image capture device (200) to comprise: base core (231), camera application (232), shot application (233), image recovery application (234) and the operation of the control circuit (210) and control program (230) of the image capture device (200) make possible the synchronized capture of images thanks to several image capture devices (200) mounted on the same arrangement (setup) and also allow the transmission of such images by means of USB or Wi-Fi communication to a remote application server.

6. EQUIPMENT TO OBTAIN 3D IMAGE DATA OF A FACE, according to claim 1, characterized by the image capture devices (200) having specific electronics and programming to capture a series of bidimensional image series from several angles of the user's face, and then transmit them via Internet to an application server located remotely from the capture site, which is in charge of processing, generating and storing a tridimensional model of the user's face; and the capture of images from the user's face can be performed with the simultaneous shot of a variable number ranging from 5 to 40 of image capture devices (200).

7. AUTOMATIC METHOD FOR CUSTOMIZED MODELING AND MANUFACTURING OF EYEGLASS FRAMES, by means of equipment to obtain data from claim 1, characterized by comprising the following steps:
A. ACQUISITION of a series of bidimensional images from several user's face angles, obtained by a capture module (100) and transmitted to a remote application server;
B. DETERMINATION of tridimensional image points of interest of the user's face performed in a remote application server and built by means of images obtained in capture module (100);
C. SELECTION by the user in any terminal connected to the Internet of the desired eyeglass frame model among a wide range of models offered;
D. CUSTOMIZED MODELING of a selected eyeglass frame according to the data from the tridimensional image points of interest generated and to the measurement of iris diameter, as well as to the personal data of the user such as gender, race and age group;
E. PERSONALIZATION (optional) with aesthetic or functional elements added by the user to the eyeglass frame model selected and modeled in a customized manner to the user's own facial features;
F. PREPARATION of technical drawing and sending of programming to a manufacturing machinery to manufacture the chosen eyeglass frame model in a customized manner according to the facial features and, optionally, personalized by the user; and
G. MANUFACTURING (automated) of the selected eyeglass frame model, modeled in a customized manner and optionally personalized by the user.

8. AUTOMATIC METHOD FOR CUSTOMIZED MODELING AND MANUFACTURING OF EYEGLASS FRAMES, according to claim 7, characterized by in possession of the user's face images obtained and transmitted by image capture devices (200) at the acquisition step (A) the control program (230) running in the remote application server determines the points of interest of the user's face tridimensional image (B) so that any selected frame is automatically adjusted and modeled in a customized manner to the dimensional characteristics of the referred user's face and the definition of points of interest of the user's face uses independent algorithms to identify iris and detect ears, by analyzing the signals related to frontal and side images of the user's face.

9. AUTOMATIC METHOD FOR CUSTOMIZED MODELING AND MANUFACTURING OF EYEGLASS FRAMES, according to claim 7, characterized by frames obtained through the method proposed in this invention having dimensional tolerances within the international standards for conventional methods of computational optics and allowing the user to select (C) the desired frame within a set of different models and styles.

10. AUTOMATIC METHOD FOR CUSTOMIZED MODELING AND MANUFACTURING OF EYEGLASS FRAMES, according to claim 7, characterized by allowing the user to optionally personalize (E) the frame model, including graphisms, phrases or reliefs and allow the user to visualize the selected frame (C), virtually positioned to the face, including the applied personalization, in order to conclude the customization (D) and personalization (E) steps in a safe manner, which will influence the user's final decision on the manufacturing (G) of the frame.
